(19) United States
(12) Patent Application Publication
(10) Pub. No.: US 2025/0381095 A1
(43) Pub. Date: Dec. 18, 2025

(54) STEERING DEVICE

(71) Applicant: SHENZHEN LOVE SENSE TECHNOLOGY CO., LTD., Shenzhen (CN)

(72) Inventors: Dan LIU, Singapore (SG); Jilin QIU, Singapore (SG)

(73) Assignee: SHENZHEN LOVE SENSE TECHNOLOGY CO., LTD., Shenzhen (CN)

(21) Appl. No.: 18/745,656

(22) Filed: Jun. 17, 2024

(30) Foreign Application Priority Data
Apr. 19, 2023 (CN) 202320888475.3

(51) Int. Cl. A61H 23/00

(52) U.S. Cl. CPC A61H 23/00; A61H 2201/0107; A61H 2201/013

(57) ABSTRACT

A steering device includes a main holder, a steering member and a restraining member. The main holder is provided with a first plate and a second plate, as well as with a female coupling which can be connected to a base of a massage tool. The steering member is connected between the first plate and the second plate, and one end thereof is provided with a male connector fixedly connected to the tool for connecting a main part of the massage tool to be used by a user. The restraining member is located on the side of the first plate backing away from the second stopper, and the restraining member is capable of retraining against the first plate and actuating the first plate closer to the second plate so as to clamp or loosen the steering member.

### CROSS-REFERENCE TO RELATED APPLICATIONS

The present application claims priority under 35 USC 119 from Chinese patent application No. 202320888475.3, filed Apr. 19, 2023, the entire contents of which are incorporated herein by reference.

### TECHNICAL FIELD

The present application relates to the field of lifestyle healthcare technology, in particular to a steering device.

### BACKGROUND

In daily life, people often need to fix the massage tool at a certain angle when using tools with vibration function (referred to as massage tools) such as fascia guns and health care massage devices. However, most of the existing massage tools can only be fixed perpendicularly to the external surface along its own length direction, such as vertically placed on the ground or desktop, or horizontally adsorbed on the wall.

### SUMMARY OF THE INVENTION

A main holder, the main holder is provided with a first plate and a second plate arranged relative to each other, and a female coupling, the female coupling being used for detachable connection with the base;
a steering member, connected between the first plate and the second plate, one end of the steering member being provided with a male coupling for detachable connection with a body of the massage tool;
a restraining member, the restraining member being disposed on the side of the first plate backing away from the second plate, the restraining member being capable of restraining against the first plate and driving the first plate closer to the second plate to clamp the steering member.

In one embodiment, the connection between the first plate and the body of the main holder is resilient.

In one embodiment, a limiting shaft is also included, the limiting shaft passing through the first plate, the steering member and the second plate in turn, and the restraining member being threadedly connected to the limiting shaft.

In one embodiment, the second plate is provided with a polygonal through-hole, and a portion of the limiting shaft disposed within the polygonal through-hole is affixed to an inner wall of the polygonal through-hole.

In one embodiment, a side of the steering member closing to the second plate is provided with a plurality of second gear teeth, the plurality of first gear teeth being arranged in evenly spaced rows along an outer peripheral surface of the limiting shaft, and the steering member is provided with a plurality of second gear teeth capable of engaging the first gear teeth on the side proximate to the second plate.

In one embodiment, an angle between two said first teeth adjacent to each other is from 8 degrees to 15 degrees.

In one embodiment, the restraining member comprises a nut threadedly connected to the limiting shaft and a rotating member, the rotating member being configured to be able to be socketed onto the nut.

In one embodiment, further comprising an suction cup holder, the suction cup holder being removably connected to a female coupling of the holder, the suction cup holder being used to be fixedly connected to an external surface.

In one embodiment, a connecting shaft is also included, both ends of the connecting shaft are provided with a first external thread, the main holder and the suction cup holder being configured to be capable of being threadedly connected to the connecting shaft.

In one embodiment, the male coupling is provided with a second male thread threaded to the body of the massage tool.

### BRIEF DESCRIPTION OF THE FIGURES

FIG. 1 shows a schematic view of the structure in one of the embodiments of the present application.

FIG. 2 shows a schematic diagram of the structure from another viewpoint in the embodiment of FIG. 1.

FIG. 3 shows an exploded schematic diagram in the embodiment of FIG. 2.

FIG. 4 shows a schematic diagram of the structure of the first teeth.

FIG. 5 shows a side view of massage tool.

FIG. 6 shows a perspective view of a main body of the massage tool.

FIG. 7 shows a perspective view of a base of the massage tool.

Appendix markings: massage tool 1; massage tool main body 10; blind via hole 11; internal thread 12; massage tool base 20; connecting shaft 21; main holder 110; female coupling 111; first plate 120; steering member 130; male coupling 131; channel 132; second gear teeth 133; second plate 140; polygonal through-hole 141; first gear teeth 142; restraining member 150; nut 151; rotating member 152; limiting shaft 160; suction cup holder 170, connecting shaft 180.

### DETAILED DESCRIPTION

In order to make the above purposes, features and advantages of the present application more apparent and understandable, the following description of specific embodiments of the present application is set forth in detail in conjunction with the accompanying drawings. Many specific details are set forth in the following description to facilitate a full understanding of the present application. However, the present application can be implemented in many other ways different from those described herein, and those skilled in the art can make similar improvements without violating the connotation of the present application, so the present application is not limited by the specific embodiments disclosed below.

In the description of the present application, it is to be understood that if any of these terms “center”, “longitudinal”, “lateral”, “length”, “width”, “thickness”, “top”, “bottom”, “front”, “back”, “left”, “right”, “vertical”, “horizontal”, “top”, “bottom”, “inside”, “outer”, “clockwise”, “counterclockwise”, “axial”, “radial”, “circumferential”, etc. These terms indicate orientations or positional relationships based on those shown in the accompanying drawings, and are intended only to facilitate the description of the present application and to simplify the description, and are not intended to indicate or imply that the device or element referred to must have a particular orientation, be constructed and operated in a particular orientation and therefore are not to be construed as a limitation of this application.

Furthermore, if the terms “first” and “second” appear, these terms are used for descriptive purposes only, and are not to be construed as indicating or implying relative importance or implicitly specifying the number of technical features indicated. Thus, a feature defined with “first” or “second” may include at least one such feature, either explicitly or implicitly. In the description of the present application, if the term “plurality” appears, “plurality” means at least two, e.g., two, three, etc., unless otherwise expressly and specifically limited.

In this application, unless otherwise expressly specified and limited, where the terms “mounting”, “connecting”, “connecting”, “fixing”, etc. appear, these terms shall be used. “and the like, these terms are to be broadly construed. For example, it may be a fixed connection, a removable connection, or a one-piece connection; it may be a mechanical connection or an electrical connection; it may be a direct connection or an indirect connection through an intermediate medium, and it may be a connection within the two elements or an interaction between the two elements, unless otherwise expressly limited. For those of ordinary skill in the art, the specific meanings of the above terms in this application may be understood on a case-by-case basis.

In the present application, unless otherwise expressly provided and limited, if there is a similar description such as the first feature is “on” or “under” the second feature, the meaning may be that the first and second features are in direct contact or the first and second features are indirectly in contact through an intermediate medium. (b) the first feature is in direct contact with the second feature, or the first and second features are in indirect contact through an intermediary medium. Furthermore, the description of the first feature being “above”, “above” and “above” the second feature may mean that the first feature is directly above or diagonally above the second feature, or simply that the first feature is horizontally higher than the second feature. above the second feature. The first feature is “below”, “under” and “underneath” the second feature may be that the first feature is directly below or diagonally below the second feature, or simply that the first feature is less horizontal than the second feature. the second feature.

It should be noted that if an element is the to be “fixed to” or “set on” another element, it may be directly on the other element or there may be a centered element. If an element is the to be “attached” to another element, it may be directly attached to the other element or there may be both centered elements. “left”, “right”, and the like are used in this application for illustrative purposes only and are not meant to be exclusive embodiments.

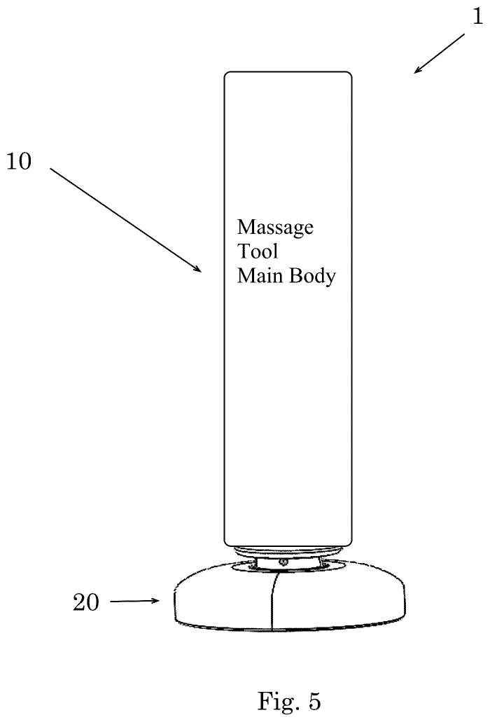

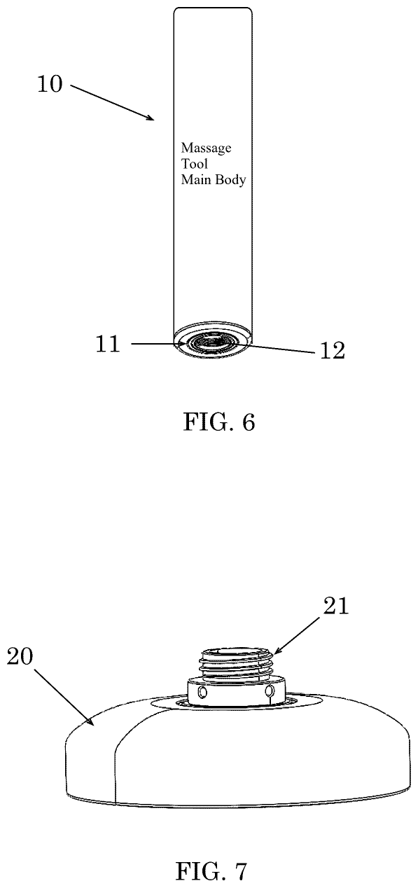

Usually, as shown in FIGS. 5 to 7, a massage tool 1 includes a main body 10 and a base 20. The main body 10 is the stimulating body and can produce a massage effect on the human body such as an erogenous area, so as to make the user produce a physical pleasure. The base 20 is mainly a suction cup, in order to be better adsorbed on a smooth surface such as a glass surface, a wall or the ground, etc. However, most existing massage tools can only be fixed perpendicularly to the external surface along its own length direction, such as by being vertically placed on the ground or a desktop, or horizontally adsorbed on a wall, resulting in an angle that is too homogenized, and can not meet the user's personalized needs, thus affecting the user's experience. In addition, due to the gradual standardization of massagetools, the main body and the base may not be the same set of products. For example, if the user buys a universal gripper, the gripper can be connected to the main body instead of the base, or if the user buys another set of massage tools but does not have a base, he or she can use the base of the other massage tools or buy his or her own suction cups, grippers, and other universal models of the base.

Referring to FIGS. 1 to 3, the present application provides a steering device (hereinafter referred to as the device) to change the angle inherent in the massage tool itself. The main components of the steering device include a main holder 110, a steering member 130 and a restraining member 150, wherein the main holder 110 is provided with an oppositely arranged first plate 120 and a second plate 140, and wherein in order to be connected to the base 20 of the massage tool 1, the main holder 110 is also provided with a female coupling 111, for example, when the base 20 of the massage tool 1 is provided with a projecting connection shaft 21 (FIG. 7) which can be an externally threaded member, the female coupling 111 is provided with a female thread with a structure that can be mated with the external thread on the connection shaft 21 of the base 20. The steering member 130 is connected between the first plate 120 and the second plate 140, and one end of the steering member 130 is provided with a male coupling 131 that is fixedly connected to the main body 10 of the massage tool 1, and it can be understood that when the base 20 of the massage tool 1 is provided with an externally threaded member, the connecting end of the main body 10 of the massage tool that is connectable with the base 20 is a blind via hole 11 with an internal thread 12, so that the male coupling 131 is a protrusion that can enter the blind via hole 11 to be connected with its thread 12. The restraining member 150 is located on the side of the first plate 120 away from the second plate 140, and the restraining member 150 can restrain against the first plate 120 and drive the first plate 120 closer to the second plate 140 to clamp the steering member 130.

The steering device, described above, comprises a main holder 110, a steering member 130, and a restraining member 150. The existing massage tool 1 includes a main body 10 and base 20, which can be a suction cup, and the main body 10 and the base 20 (suction cup) are threadedly connected or snap-jointed (by their blind via hole 11 and connection shaft 21) to realize a detachable connection. In this configuration, the angle between the main body 10 and the base 20 is difficult to change. With the steering device of this application, when the angle of the main body 10 of the massage tool 1 is required to be different from the angle of the base 20, the main body 10 and the base 20 can be detached from each other and then connected to the steering device of this application. As described above, and the main holder 110 of the steering device is provided with a first plate 120 and a second plate 140 on the side of the main holder 110 away from a suction cup holder. The steering member 130 is connected between the first plate 120 and the second plate 140, and one end of it is provided with a male coupling 131 to connect the body 10 of the massage tool 1 to be used by the user. The restraining member 150 is located on the side of the first plate 120 away from the second plate 140, and the restraining member 150 is capable of restraining against the first plate 120 and driving the first plate 120 closer to the second plate 140 so as to clamp or relax the steering member 130. The main holder 110, on the other hand, is connected to the base 20 (suction cup) of the massage tool, and is fixed to an external surface such as a wall or a floor using the suction cup of the massage tool 1. The steering device provided in this application allows the steering member 130 to be set to a predetermined angle, and then the distance between the first plate 120 and the second plate 140 is adjusted by means of the restraining member 150, so as to be able to clamp the steering device, so that the steering device can be fixed at a certain angle and not move, and thus the massage tool 1 used by the user can be set at an arbitrary angle, which effectively improves the user's feeling of using the massage tool.

Thus, a steering device is provided in response to the problem of a massage tool having a single angle during use. The steering device can be fixedly connected to the massage tool and utilized to pre-adjust and fix the angle that is desired to be set prior to the use of the massage tool

It is to be understood that the female coupling 111 of the main holder 110 in the present application can be connected not only to the base 20 of the massage tool 1 itself, but also to other tools such as grippers, suction cups, etc., which are purchased separately by the user to fix external surfaces.

The steering device provided in the present application sets the steering member 130 to a predetermined angle in advance, and then adjusts the distance between the first plate 120 and the second plate 140 by means of the restraining member 150, so as to be able to clamp the steering member 130, so that the steering member 130 can be fixed at a certain angle and not move, and then the main body 10 of the massage tool 1 is fixedly connected to the steering member 130, so that the massage tool 1 used by the user can realize the use of any angle, which effectively ensures the user's feeling of use.

It can be understood that in the above embodiments, when the steering member 130 is not connected to the first plate 120 and the second plate 140 respectively, the steering member 130 fixes the angle mainly through the static friction between it and the first plate 120 and the second plate 140.

In one embodiment, the connection between the first plate 120 and the body of the main holder 110 is resilient.

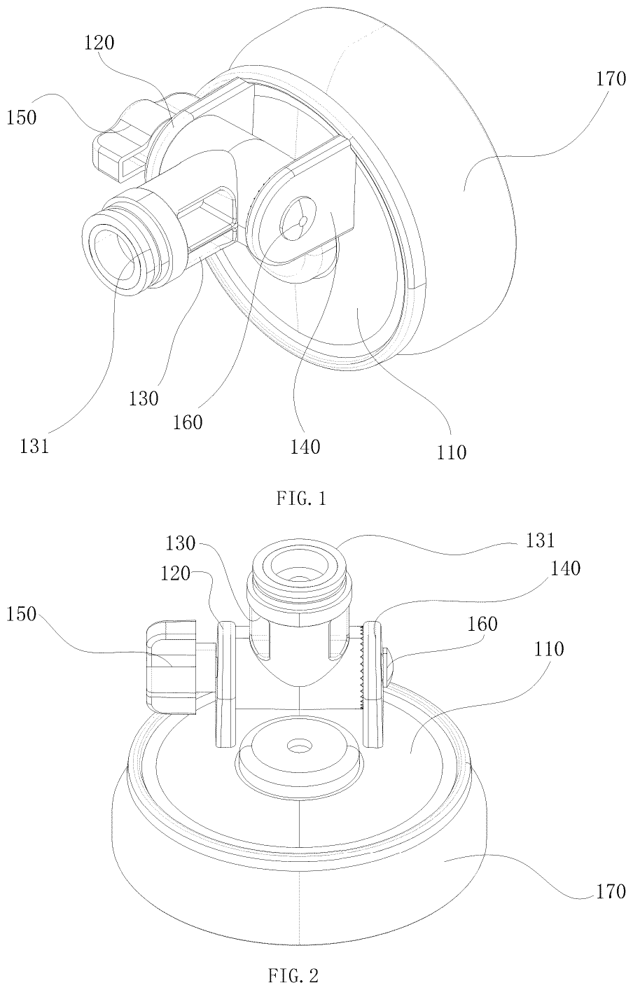

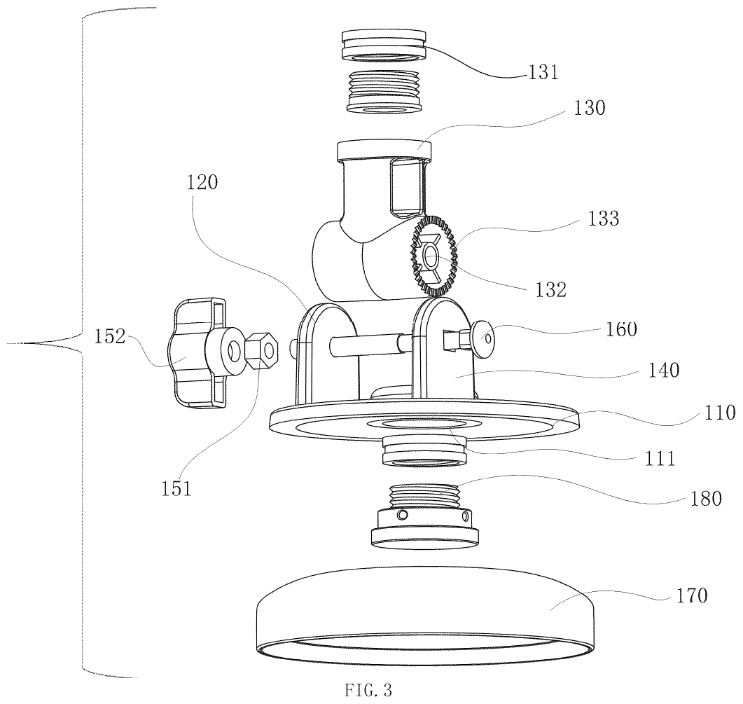

Specifically, the rest of the main holder 110 may be made of a harder material, such as stainless steel, in addition to the elasticity of the connection as described above. Since the connection is elastic, the first plate 120 can be deflected relative to the main body of the main holder 110, referring to FIG. 1 or FIG. 2. Since the first plate 120 is in the shape of a plate, the deflection that occurs along the thickness direction is inevitably easier as well as of greater magnitude than the deflection that occurs along the width direction. Therefore, when the steering member 130 is adjusted at an angle, the restraining member 150 can push the first plate 120 towards the steering member 130 in its thickness direction until it clamps the steering member 130 together with the second plate 140. The connection between the first plate 120 and the main body of the main holder 110 has an elasticity production cost that is low and effective.

Referring to FIG. 3, in one embodiment, a limiting shaft 160 is also included. The limiting shaft 160 passes through the first plate 120, the steering member 130, and the second plate 140 in turn, and the restraining member 150 is threadedly connected to the limiting shaft 160. The limiting shaft 160 prevents the problem of too little static friction between the steering member 130 and the first plate 120 and the second plate 140, which may cause the steering member 130 to disengage from the main holder 110.

Specifically, the first plate 120, the second plate 140 are provided with through holes for the limiting shaft 160 to pass through, and the steering member 130 is provided with a channel 132 for the limiting shaft 160 to pass through, and the restraining member 150 is threadedly connected to the limiting shaft 160. By rotating, the restraining member 150 can adjust the length of the limiting shaft 160 disposed between the first plate 120 and the second plate 140 such that a length of the limiting shaft 160 between the first plate 120 and the second plate 140 is shorter or longer for better clamping or loosening of the steering member 130.

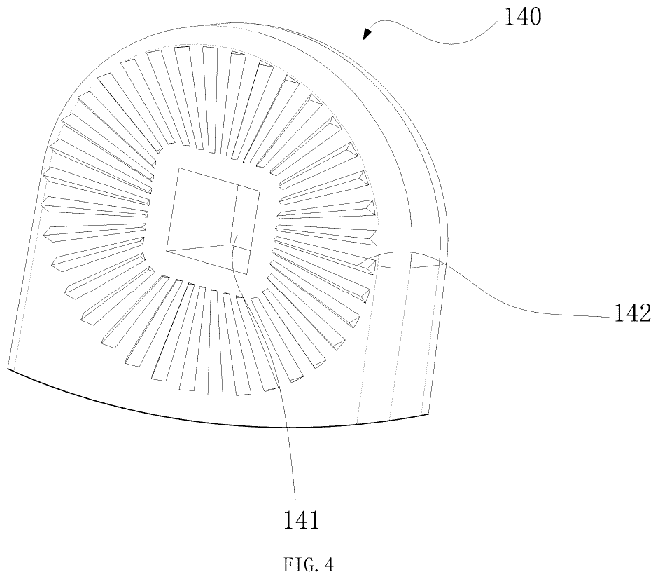

Referring to FIG. 3 or FIG. 4, in one embodiment, the second plate 140 is provided with a polygonal through-hole 141, and a portion of the limiting shaft 160 disposed within the polygonal through-hole 141 is restrained by an inner wall of the polygonal through-hole 141. When the restraining member 150 is rotated relative to the limiting shaft 160, the portion of the limiting shaft 160 within the polygonal through-hole 141 will not be rotated synchronously because the portion of the limiting shaft 160 within the polygonal through-hole 141 is also polygonal, thereby eliminating the need for the user to hold the limiting shaft 160 in place with one hand and rotate the restraining member 150 with the other hand.

Referring to FIGS. 3 and 4, in one embodiment, a side of the steering member close to the second plate 140 is provided with a plurality of second gear teeth 133. A plurality of first gear teeth 142 are provided on the second plate 140 evenly spaced apart along the outer periphery of the limiting shaft 160, and the second gear teeth 133 of the steering member 130 are capable of engaging with the first gear teeth 142 on a side near the second plate 140. The engagement of the first gear teeth 142 and second gear teeth 133 further reduces the need for a user to fix the limiting shaft 160 with one hand. The engagement of the first gear teeth 142 and the second gear teeth 133 further reduces the dependence on static friction, and when the steering member 130 is clamped, the fixed angle is more reliable through the engagement of the first gear teeth 142 and second gear teeth 133, and at the same time, when the angle is adjusted, due to the distribution of the first gear teeth 142 and the second gear teeth 133, it can be used as a parameter for the adjustment of the angle, which makes the adjustment more convenient.

Preferably, in one embodiment, the angle between two adjacent first gear teeth 142 is 8° to 15°. In this angular range, the number of teeth of the first gear teeth 142 circling the limiting shaft 160 is between 45 and 24. A steering member can be adjusted by setting a reference point, and the number of first gear teeth 142 circling this point multiplied by the angle of the two adjacent first gear teeth 142 is the angle of rotation of the steering member, so as to be convenient for the user to use.

In one embodiment, the restraining member 150 comprises a nut 151 threadedly connected to the limiting shaft 160 and a rotating member 152, the rotating member 152 being configured to be able to be socketed on the nut 151.

It can be understood that the main body of the restraining member 150 is a nut 151, which has an internal thread that cooperates with the external thread of the limiting shaft 160, and in order to make the user hold it with less effort, the restraining member 150 also includes a rotating member 152, which is larger in size along the radial direction of the nut 151. The rotating member 152 can be socketed onto the nut 151, and by rotating the rotating member 152, the nut 151 can be driven to rotate synchronously with the nut 151. The nut 151 can be driven to rotate synchronously, thereby elongating or shortening the length of the limiting shaft 160 between the first plate 120 and the second plate 140.

Referring to FIG. 1, in one embodiment, the present application also provides the suction cup holder 170, which can replace the base 20 of the massage tool 1 or other adsorption tools when the base 20 of the massage tool 1 or other purchased tools such as a gripper or suction cup are lost or broken or otherwise unusable. The suction cup holder 170 is detachably connected to the female coupling 111 of the main holder 110. The suction cup holder 170 can be adsorbed on a surface such as a floor, a wall, a glass surface, a tile surface, and the like. Specifically, the suction cup holder 170 can be made of rubber material to achieve better elasticity. The shape of the suction cup holder 170 is similar to that of a toilet plug, provided with a gas chamber and an opening, and when it is necessary to use the suction cup holder 170, the gas capacity of the gas chamber will change by squeezing the suction cup holder 170 to deform it, and when the opening of the suction cup holder 170 is pressed against the external surface, the opening can be blocked by the external surface, so that when the suction cup holder 170 recovers the shape, the internal gas density will change. When the suction cup holder 170 is restored to shape, the density of the gas inside will change, resulting in the gas pressure inside the gas cavity being less than the outside atmospheric pressure to enable the suction cup holder 170 to be adsorbed on the outside surface. Similarly, when removal is required, the device can be removed by re-squeezing the suction cup holder 170 so that the internal gas pressure is greater than the external air pressure.

It will be appreciated that the suction cup holder 170 is not only made of rubber, but the portion thereof connected to the main holder 110 may be made of a harder material such as stainless steel, in order to accomplish a removable threaded connection.

Referring to FIG. 3, in one embodiment, a connecting shaft 180 is also included. Both ends of the connecting shaft 180 are provided with external threads, and the main holder 110 and the suction cup holder 170 are configured to be capable of being threadedly connected to the connecting shaft 180.

Specifically, the main body of the main holder 110 and the suction cup holder 170 are connected by a threaded connection, which is a simple method, and the components are easy to process and easy to disassemble for cleaning.

Preferably, as illustrated in FIG. 3, both the main holder 110 and the suction cup holder 170 are provided with snap-in members, and the two snap-in members are threaded through the connecting shaft 180, and then the two snap-in members are respectively snap-coupled with notches of the main holder 110 and the suction cup holder 170.

In some other embodiments, it is also possible to use a removable connection such as a snap joint, or to directly set up the main body of the main holder 110 and the suction cup holder 170 as a single unit, in order to reduce the number of components and improve the durability of the whole device.

In one embodiment, the steering member 130 is provided with a weight reduction hole. Understandably, the steering member 130 is provided skeletonized or configured with weight reducing holes in order to reduce the weight of the entire device and also to facilitate cleaning.

Referring to FIG. 1 in one embodiment, the male coupling 131 is provided with a male thread for threading with the massage tool.

Understandably, the shape of the male coupling 131 or the connecting feature needs to be decided according to the massage tool to be used by the user, for example, if the massage tool 1 has a thread, the male coupling 131 may be provided with an internal or external thread to cooperate with the thread of the massage tool 1. Since the number of existing massage tools is not very varied and they are all marketed and standardized, a variety of types of male couplings 131 can be made to accommodate the multiple types of massage tools.

In the steering member illustrated in FIG. 1, the male coupling 131 is provided with a male thread for threading with a massage tool to thread with an existing massage tool of some kind.

The various technical features of the above-described embodiments may be combined in any way, and for the sake of brevity of description, all possible combinations of the various technical features of the above-described embodiments have not been described, however, as long as there is no contradiction in the combinations of these technical features, they should be considered to be within the scope of the present specification as recorded herein.

The above-described embodiments express only several embodiments of the present application, which are described in a more specific and detailed manner, but are not to be construed as a limitation of the scope of the patent application. It should be pointed out that, for a person of ordinary skill in the art, a number of deformations and improvements can be made without departing from the conception of the present application, all of which fall within the scope of protection of the present application. Therefore, the scope of protection of the patent application shall be subject to the attached claims.

1. A massage tool comprising:
a main body usable for massaging and having a first female coupling,
a base having a first male coupling, the main body and the base being detachably connected via the first female coupling and the first male coupling; and
a steering device that is configured to be removably interposed between the main body and the base of the massage tool, to enable positional adjustment of the main body relative to the base;
wherein the steering device comprises:
a main holder, the main holder being provided with a first plate and a second plate arranged opposite to each other, and with a second female coupling;
a steering member, connected between the first plate and the second plate, one end of the steering member being provided with a second male coupling; and
a restraining member, the restraining member being disposed on a side of the first plate away from the second plate, the restraining member being able to restrain against the first plate and drive the first plate towards the second plate in order to clamp the steering member,
wherein the second female coupling is configured to engage with the first male coupling of the base, and the second male coupling is configured to make a direct and detachable connection with the first female coupling of the main body, to interpose the steering device between the main body and the base, and
wherein the steering device is selectively engageable between the main body and the base when rotation or directional adjustment of the main body is desired, and removable from between the main body and the base when such rotation or adjustment is not required, thereby enabling the massage tool to function in a dual-use configuration with or without the steering device connected.

2. The massage tool of claim 1, wherein, in the steering device, a connection between the first plate and a body of the main holder is resilient.

3. The massage tool of claim 1, the steering device further comprising:
a limiting shaft, the limiting shaft passing sequentially through the first plate, the steering member, and the second plate,
wherein the restraining member is threadedly connected to the limiting shaft.

4. The massage tool of claim 3, wherein, in the steering device, the second plate is provided with a polygonal through hole, and a portion of the limiting shaft disposed within the polygonal through hole is engaged with an inner wall of the polygonal through hole.

5. The massage tool of claim 3, wherein, in the steering device, the second plate is provided with a plurality of first gear teeth on one side thereof closer to the first plate, the plurality of first gear teeth being evenly spaced along an outer periphery of the limiting shaft, and wherein a side of the steering member adjacent to the second plate is provided with a plurality of second gear teeth capable of engaging with the first gear teeth.

6. The massage tool of claim 5, wherein, in the steering device, an angle between two said first teeth adjacent to each other is from 8 degrees to 15 degrees.

7. The massage tool of claim 3, wherein, in the steering device, the restraining member comprises a nut threaded to the limiting shaft and a rotating member, the rotating member being configured to be able to be socketed on the nut.

8. The massage tool according to claim 1, further comprising a suction cup holder, the suction cup holder being detachably connected to the second female coupling of the main holder, the suction cup holder being usable for a fixed connection with the external surface.

9. The massage tool of claim 8, the steering device further comprising a connecting shaft, both ends of the connecting shaft being provided with external threads, the main holder and the suction cup holder being capable of being threadedly connected to the connecting shaft.

10. The massage tool of claim 1, wherein the second male coupling is provided with an external thread threaded to the main body.
